(19) United States
(12) Patent Application Publication
(10) Pub. No.: US 2008/0227616 A1
(43) Pub. Date: Sep. 18, 2008

(54) Use of Glass Ceramics

(76) Inventors: Ulrich Peuchert, Bodenheim (DE); Joerg Hinrich Fechner, Mainz (DE); Thilo Zachau, Buerstadt-Riedrode (DE); Uwe Kolberg, Mainz (DE); Paul Kissl, Mainz (DE); Rainer Liebald, Nauheim (DE); Dirk Sprenger, Stadecken-Elsheim (DE)

Correspondence Address: MICHAEL J. STRIKER, 103 EAST NECK ROAD, HUNTINGTON, NY, 11743, US

(21) Appl. No.: 10/584,789

(22) PCT Filed: Jan. 4, 2005
(86) PCT No.: PCT/EP2005/000018

§ 371 Date: Mar. 17, 2008

(30) Foreign Application Priority Data
Jan. 5, 2004 (DE) 10 2004 001 176.1
May 13, 2004 (DE) 10 2004 024 022.1

(51) Int. Cl. C03C 3/093; C03C 3/085

(52) U.S. Cl. 501/67; 501/69

(57) ABSTRACT

The invention relates to novel uses of glass ceramics, wherein glass ceramics, in particular, in the form of a glass ceramic tube, are used. Said glass ceramics contain 0—less than 4 wt % P20₅ and 0 less than 8 wt-% CaO. The tubes can be used in multiple areas of application and/or in multiple types of lamps, for example in general lighting or car lights and in heat radiators, such as halogen lamps or incandescent lamps, and/or in high pressure discharge lamps or low pressure discharge lamps. The glass ceramics, can also, in particular, be minimised in order to form known backlighting in conjunction with background lighting of flat screens. Said type of glass ceramics have excellent spectral transmission in the visible wave length rang and are solarisation stable and absorb strong UV light.

The present invention relates to novel uses of glass ceramics, wherein the glass ceramics are in particularly used in the form of a glass ceramic tube. The tubes can be used in multiple areas of application respectively in multiple types of lamps, for example in the area of general lighting or car lights respectively in temperature radiators, such as halogen lamps or incandescent lamps respectively in high pressure or low pressure discharge lamps. In particular, the glass ceramics can also be used in minimised form for the so-called “backlighting” in conjunction with background lighting of flat screens. Preferably, the glass ceramics according to the present invention are also suitable as outside bulbs for high pressure metal halide discharge lamps e.g. those having burners of Al₂O₃ ceramic, wherein the lamp bulb of the glass ceramic according to the present invention separates the space around the burner from the external atmosphere.

Glass ceramics with preferable properties for a selective use for special applications are known in the art and for example the well-known brands of the applicant, Ceran® and Robax®, are mentioned. Glass ceramics like the mentioned ones have a unique spectrum of properties resulting from selective, controlled, temperature regulated, partial crystallisation. Depending on the composition, the production manner of the starting glass (also called “green glass”) and the adjustment of the temperature regime at the hot reprocessing (which also includes the so-called “ceramication”, that is the transformation of the green glass into a glass ceramic), in a glass ceramic, different kinds of crystalline phases, crystallographic species having various crystal morphology and size as well as different amounts of crystal can be separated. So, in particular, the thermal expansion respectively the mechanical stabilities may be adjusted. An outstanding basic property of a glass ceramic such as Robax® or a glass ceramic of other chemical systems is the high thermal stability of the material which is substantially higher than those of conventional multi component glasses, in particular higher than those of the respective green glass.

While, till today, glass ceramics have been used in pane-like form as hot plates and panes for stoves and fireplaces, yet, there is no technical solution to manufacture these advantageous materials having defined properties into other more complex forms and to use them in other applications. In particular, methods for an inexpensive and reproducible production of glass ceramic tubes in a condition of ceramication which is in particular suitable for the application in the area of lamps, in suitable geometry and size and suitable in view of the property to screen off UV light, have not been described till now.

A lot of traditional lighting sources such as halogen lamps or discharge lamps have transparent cylindrical lamp bulb vessels as a key element. Inside these vessels, during the operating state usually gasses are contained which are either for protection of the heating sources (e.g. the tungsten wire, protected by halides, in halogen lamps) or are causally for the generation of light by themselves (e.g. Hg, Xe, lanthanide halides in discharge lamps). Also transparent media can serve as second jacketing bulbs as shatter protection facility, for UV blockage (screening off UV light), for thermal isolation of hot burners respectively for protection against the oxidation of passage systems (see e.g. UV blocking silica glass in high pressure discharge lamps with Al₂O₃ ceramic burners).

In particular with the use according to the present invention of glass ceramics in the form of transparent tubes in lighting sources there is an increasing interest in defined demands, for example the parameters temperature stability, optical functions, transmission properties, in this case especially in the UV range, etc.

At the moment, for lighting units in the area of halogen lamps, e.g. for automobiles, as material there are used resistance glass (usually alkali-free aluminium silicate glasses) and silica glass (SiO₂).

Translucent ceramics, such as e.g. those on the basis of Al₂O₃, are used in high pressure gas discharge lamps as ceramic burners. The production of which is conducted according to classic ceramic production methods, that is directly from crystalline powders by the use of pressure and/or temperature methods. If at all, the ceramics have only very small glass-like portions, preferably in the so-called “sinter necks” between the grain boundaries. The materials used should also be free of alkali.

Conventional ceramic materials are substantially different from glass ceramics. While in the case of a ceramic a fine, already crystalline material is melted on the surface, to be sintered then, crystals in a glass ceramic grow from the amorphous phase. Thus in a conventional ceramic, crystalline powders are densified and sintered, by which the grains become coarser and agglomerate near the surface. If there is melting in the grain boundary region and this melt solidifies in a glass-like manner at cooling, however the volume proportions of the glass-like intermediate phases are low in comparison to the glass ceramic. Namely, in the latter there remain amorphous portions between the crystalline regions which typically comprise approximately 10 to 20% by volume of the glass ceramic. But the residual glass portion can also be up to 50% by volume of the glass ceramic. While glass ceramics have an excellent transmission in the visible range, with conventional and also transmission-optimised ceramics, in particular those of Al₂O₃, there are scattering effects which limit the transmission in the range of the visible light, because of the grain boundaries and the fact that also with optimal process management, there will ever remain intergranular voids. Usually, this does not exceed 65%. However, in the transparent glass ceramic, small particles are present and the refractive index of the crystals is near to that of the glass which results in excellent transmission values in the visible range.

In low pressure discharge lamps (example: fluorescent tube) which are e.g. used in minimised form in TFT (“thin film transistor”) display devices for background lighting (“backlights”), till now there have been used multi component glasses on silicate basis in tube form. In this case the bulb glass is doped so that UV light is screened off. Here, the demand of screening off UV light by the glass of the lamp itself is of particular meaning, because other components in the flat screens, in particular polymer containing components, undergo a fast ageing and degeneration by the UV light, namely they tend to yellow and to embrittle.

Till today, for the uses as backlight multi component glasses, in particular borosilicate glasses, also doped, have been used to give UV blocking properties.

For metal halide lamps with ceramic burners, according to the state of the art there is used for example silica glass having a wall thickness of ca. between 1 mm and 1.5 mm as outside bulb material. For UV blockage, the silica glass is doped with CeO₂ in contents of usually less than 1% by weight. A disadvantage is that with this the glass has residual transmission in the range of the hard energy-rich UV C- and D-radiation, that is below 300 nm, in the order of 10% or more.

The patent document DE 37 34609 C2 relates to calcium phosphate glass ceramics which can also be used in discharge lamps. The main crystalline phase in these glass ceramics is apatite, thus the glass ceramic has a high coefficient of thermal expansion which is desired according to DE 37 34609 C2. The patent document does not disclose a glass ceramic which has a coefficient of thermal expansion of less than 6×10⁻⁶/° K.

The use of glass ceramics in the field of lamp construction is described in GB 1,139,622. Here, a composite lamp is described which consists of a part of glass ceramic and a silica glass window. The parts are connected with one another by a sealing glass containing copper. In GB 1,139,622 there is no teaching about the production of green glass bulbs or bodies respectively their further processing. The use is limited to UV and IR lightings; the emission of UV light is explicitly desired. There is no disclosure about screening off UV radiation.

U.S. Pat. No. 4,045,156 describes the use of partially crystallised glass for applications in photoflash lamps. These lamps are featured by a higher temperature resistance, higher thermo shock resistance as well as mechanical strength than conventional lamps comprising bulbs of soda-lime glass. The expansion coefficient is ca. 8.0 to 9.5×10⁻⁶/° K, mainly because of the separation of lithium disilicate crystals from corresponding starting glasses. The background is the adjustment of the glass ceramic to passage metals respectively alloys with high expansion, for example copper containing “Dumet” alloys.

U.S. Pat. No. 3,960,533 describes a further use of the glass ceramic which is described in U.S. Pat. No. 4,045,156, but now in the translucently ceramicated form as shading of the harsh tungsten filament in a light bulb. The expansion coefficients of the materials are high and the transmission is very low.

A glass ceramic having more than 50% by volume of amorphous phases which comprises Ta₂O₅ and/or Nb₂O₅ (5 to 20% by weight in the starting glass) in higher amounts is described in U.S. Pat. No. 4,047,960. However, with the use as a part of a lamp it has to be considered that with an incorporation of visible amounts of Ta₂O₅ and/or Nb₂O₅ the formation of “charge transfer complexes” in the glass ceramic results in undesired discolorations.

The object of the present invention is to provide glass ceramic materials as well as methods for their production which satisfy defined demands regarding form and properties and thus can be used for new purposes. The demanded properties are transparency in the visible range and blockage in the UV range, with good solarisation resistance, low coefficients of thermal expansion and excellent chemical resistance.

The object is solved by providing corresponding glass ceramics and their novel and inventive use as defined in the claims. The unique uses of highly stable and transparent glass ceramics made up to other demands greatly exceed the present use of conventional glasses, conventional ceramics and calcium phosphate glass ceramics according to the state of the art and offer, in particular in the case of low pressure lamps (“backlight”), advantages in the field of “UV blockage” at high total transparency. The same belongs to the use of tubular respectively tube-like glass ceramics as outside bulbs in HID (high intensity discharge) lamps, wherein here “tubular” means a hollow article with an outer wall and at least one opening, the cross-section of which is circular, whereas “tube-like” refers to corresponding cross-sections of another closed geometry, e.g. elliptical, oval or “well-rounded-angular”.

With the use of the glass ceramics according to the present invention, they can be present in the form of tubes, which is in particular useful, when the glass ceramic is used as a part of a lamp. Tubes can be transformed into spherical or ellipsoidal forms, if necessary. Independently of a preceding tube form, hollow spheres or hollow ellipsoids can also be prepared directly by blowing or pressing.

Demands regarding the glass ceramics for the uses according to the present invention are properties such as for example good temperature stability with superior transparency.

As to the temperature stability, it should be higher than those of resistance glass. Conventional glasses which may be used here and which are e.g. from the type aluminium silicate glass, have transformation temperatures (Tg) in the range of 700 to 800° C. At such temperatures, the glass is in the solid state yet.

Since no so-called “Tg” can be determined for glass ceramics, it is useful to determine a yet stable condition which is dependent of the temperature, on the basis of the viscosity of the glass ceramic in dependence of the temperature. Such viscosity measurements are shown and explained in example 3 below. A suitable glass ceramic should not have the ability to flow in a viscous manner even at higher temperatures and it should withstand lamp operation temperatures of higher than 800° C., preferably of higher than 900° C. and further preferably of higher than 1000° C.

Ideally, the flow in a viscous manner of a glass ceramic according to the present invention sets in at higher temperatures than with silica glass, most preferably, the glass ceramic is as stable as or more stable as translucent ceramics, e.g. such ones on the basis of Al₂O₃.

Besides the superior temperature stability, the glass ceramics should have a high transmission in the visible range (between 380 nm and 780 nm) at a layer thickness of 0.3 mm, for example of higher than 75%, preferably of higher than 80%, particularly preferably of higher than 90%, which property is important for the use of the glass ceramics as parts of a lamp. Further especially preferably are glass ceramics which have at a wall thickness of 1 mm in the wave length range between 400 and 780 nm a transmission of higher than 75%, particularly preferably of higher than 80%.

In particular with the use for the background lighting in TFT display devices, a good UV blockage (screening off UV light) is important. Blockage means a transmission of less than 1% at a layer thickness of 0.3 mm. The blockage can be achieved for wave lengths of equal to or lower than 260 nm, preferably of equal to or lower than 300 respectively of equal to or lower than 315 respectively of equal to or lower than 365 nm.

For some uses according to the present invention, it should be possible to fuse the glass ceramic respectively the green glass with the electrical passages which according to the uses consist of molybdenum, tungsten or alloys such as Vacon 11® (“Kovar”). Thus, a long-term hermetically proof seal between the electrically and thermally conductive metal passage and the bulb material can be provided and problems which are created by different properties regarding the thermal expansion of the materials glass and metal can be solved.

Thus, coefficients of thermal expansion α_{20/300} of between 0 and less than 6×10⁻⁶/° K, preferably of between 3×10⁻⁶/° K and 5.5×10⁻⁶/° K, can be achieved. For fusions with tungsten, expansion coefficients of between 3.4×10⁻⁶/° K and 4.4×10⁻⁶/° K and for fusions with molybdenum, expansion coefficients of between 4.2×10⁻⁶/° K and 5.3×10⁻⁶/° K are particularly preferably. For Fe—Ni—Co alloys, according to the composition of the alloys (e.g. KOVAR, Alloy 42), expansion coefficients of between 3.8×10⁻⁶/° K and 5.2×10⁻⁶/° K are particularly preferably. Also glass ceramics with very low expansion having expansions in the range of 0×10⁻⁶/° K can be used in the field of lamp construction.

In this case, the glass ceramic can be designed so that the thermal expansion of the electrode material consisting of metal will approximate, which has the advantage that also at operation temperature during the operation of the lamp no leaks are generated.

For the novel uses of the glass ceramics according to the present invention, it is also important that the materials are chemically resistant, so that e.g. processes in a lamp are not influenced on a long term. With the use in halogen lamps, in particular a disturbance of the halogen cycle should be avoided. The materials should not be permeable by fillers, thus, they should have good long-term proofness. Also, hot fillers under pressure should not result in corrosion.

If necessary and useful, for the use in lamps, the glass ceramics should be free of alkali, at least in the upper layers of the inside tube surface, preferably in the whole lamp bulb body, and should fulfil highest demands regarding purity. The so-called “colour rendering index” (CRI) should be optimal for a long term, e.g. CRI of higher than 90, preferably CRI of ca. 100.

The glass ceramics which are used according to the present invention contain phosphorus for the stabilisation of the glass phase, however not in a main crystalline phase and in particular no main crystalline phase of apatite. This imparts preferable properties and is achieved by the limitation of the amount of P₂O₅ and/or CaO. In the glass ceramic only 0 to less than 4% by weight of P₂O₅ and/or 0 to less than 8, preferably 0 to 5% by weight of CaO are present. Particularly preferably, the content of CaO is only 0 to 0.1% by weight. According to an embodiment according to the present invention also glass ceramics may be used which contain both, the above mentioned defined content of phosphorus oxide and a defined content of CaO.

The glass ceramics which are used according to the present invention and which can exist for example in the form of a tube, are prepared by means of ceramication programs known to a person skilled in the art. The ceramication program has to be designed so that the glass ceramic obtained is optimised for the respective use regarding the corresponding needed properties.

For an optimal thermal stability, it may be suitable to minimise the glass portion in the glass ceramic, i.e. for example, to adjust a proportion of a crystalline phase to at least 50% by volume, preferably at least 60% by volume, further preferably 70% by volume, particularly preferably 80% by volume and/or to adjust the composition of the residual glass phase near to that of pure silica glass.

The ceramication programs are adjusted regarding temperature and time regimes and they are adjusted to desired crystalline phases as well as to the ratio of residual glass phase and portion of crystalline phase as well as to crystallite size.

Further, by the ceramication program, the surface chemistry respectively a depth profile for certain elements may be adjusted, thus in the course of the ceramication in regions near the surface a desired content of alkalis may be adjusted, also as a fine adjustment of “alkali-poor” to “alkali-free”.

During the ceramication also a concentration gradient of certain elements can be created which may be effected by their incorporation into the crystalline phase respectively their remaining/enrichment in the residual glass phase, in particular by the creation of a glass-like surface layer, the thickness and composition of which can be determined by the composition of the starting glass and the ceramication atmosphere.

The ceramication is also possible directly during the operation of the lamp (“in situ ceramication”) by an adjustment of certain courses of current-voltage-time which result in a heat emission of the spiral of the lamp, with which corresponding temperatures of nucleation and crystal growth as well as rates of heating and cooling inside the body of the lamp can be achieved.

Both, the composition of the starting glass and also the ceramication program are further adjusted to the desired amount of screening off UV radiation, regarding to the regime of nucleation respectively crystal development, if necessary.

The UV blockage properties (position/steepness of the absorption edge) of the glass ceramic can be made up by a series of measures: Besides the introduction of UV blocking additives, such as e.g. TiO₂, for glass ceramics in comparison to glasses further adjustment possibilities are given: particle size (adjusted regarding to maximum UV scattering), distribution of particle sizes (the higher the homogeneity of the size of the particles, the greater the steepness of the edge). The glass ceramic can also be adjusted regarding to starting glass and ceramication status so that the active doping agent Ti ideally distributes in the residual glass phase and crystalline phase. The bigger the crystal particles are, the higher the properties of screening off UV light. Preferable particle sizes are in the range of 10 to 100 nm, wherein a distribution of particle sizes which is as monomodal as possible is preferred and preferable at least 60% of the particles which are present are in this range of sizes, wherein preferably the proportion of the crystalline phase of the total volume is at least 50% by volume and at most 90% by volume.

In this way, it is prevented that the total transmission in the range about higher than 400 nm is lowered and at the same time a steep UV edge in the range of 360 to 400 nm is achieved. By variants of the ceramication conditions, the UV blockage can be specifically adjusted. The ceramicated tube, regarding to the UV blockage properties, is superior in comparison to a non-ceramicated tube of the same composition, that is its green glass tube. Therefore, it is excellently suitable for the uses according to the present invention.

Also ceramication regimes for the generation of a hermetically proof crossing from the glass to an electrical passage are possible. In this case, the assumption can be made that through shrinkage of the material during the ceramication favourable stress conditions (axial/radial) are generated and thus a hermetically proof connection is provided. By the use of glass ceramic materials which are adjusted in their thermal expansion (preferably in glass-like as well as ceramicated condition), also more massive metal passages (instead of very thin Mo plates, used e.g. in halogen lamps on the basis of silica glass, silica glass as outside bulb for HID lamps) can be used which should also be in favour of a better thermal dissipation from the lamp.

Also by suitable ceramication or the use of suitable heating methods for the transformation of the starting glass, a condition may be adjusted at which the lamp “is sealed by itself” during operation.

Preferably used, in particular in the area of halogen lamps and gas discharge lamps, are substantially alkali-free glass ceramics (GC) which are also referred to as “AF-GC” having the following compositions in % by weight:

| | |
|---|---|
| 35 to 70, | preferably 35 to 60 SiO₂ |
| 14 to 40, | preferably 16.5 to 40 Al₂O₃ |
| 0 to 20, | preferably 6 to 20 MgO |
| 0 to 15, | preferably 0 to 4 ZnO |
| 0 to 10, | preferably 1 to 10 TiO₂ |
| 0 to 10, | preferably 1 to 10 ZrO₂ |
| 0 to 8, | preferably 0 to 2 Ta₂O₅ |
| 0 to 10, | preferably 0 to 8 BaO |
| 0 to less than 8, | preferably 0 to 5 and further preferably 0 to 0.1 CaO |
| 0 to 5, | preferably 0 to 4 SrO |
| 0 to 10, | preferably more than 4 to 10 B₂O₃ |
| 0 to less than 4 | P₂O₅ |
| 0 to 4 | conventional fining agents, such as e.g. SnO₂ + CeO₂ + |
| | SO₄ + Cl + As₂O₃ + Sb₂O₃ |

The glass ceramics are characterized by the main crystalline phases spinel, sapphirine, mixed high quartz crystal (HQMK), alpha-quartz, cordierite and respective mixed crystals (in particular Zn spinels/sapphirines; Mg/Zn HQMK). As main crystalline phase, a crystalline phase is meant which proportion with respect to the sum of all crystalline phases is higher than 5% by volume.

As minor crystalline phases (those crystalline phases which have a proportion with respect to the sum of all crystalline phases of less than 5% by volume) ilmenites (M²⁺TiO₃), ilmeno rutiles (M³⁺ₓTi⁴⁺_{y})O_{2y+1.5x} or rutiles (M⁴⁺ₓTi_{y}O_{2x+2y}) may be present. Calcium containing crystalline phases, such as e.g. anorthite (CaAl₂Si₂O₈) or calcium phosphate (in particular apatite), are not desired as main crystalline phases due to their known opacifying effect and low chemical resistance, the formation of which is prevented by the amounts of phosphorus oxide and/or calcium oxide in the glass ceramic.

Main crystalline phases of aluminium niobate and/or aluminium tantalate and/or aluminium niobates-tantalates are also undesired. Preferably less than 5% by weight of niobium and/or tantalum oxide are used in the starting melt.

As alkali-containing glass ceramics, which are referred to as “AH-GC”, according to the present invention for example the following compositions (in % by weight) can be used, in particular in the use for (optionally minimised) low pressure discharge lamps:

| | |
|---|---|
| 60 to 70 | SiO₂ |
| 17 to 27 | Al₂O₃ |
| more than 0 to 5 | Li₂O |
| 0 to 5 | MgO |
| 0 to 5 | ZnO |
| 0 to 5 | TiO₂ |
| 0 to 5 | ZrO₂ |
| 0 to 8 | Ta₂O₅ |
| 0 to 5 | BaO |
| 0 to 5 | SrO |
| 0 to less than 4 | P₂O₅ |
| 0 to 4 | conventional fining agents, such as e.g. SnO₂ + |
| | CeO₂ + SO₄ + Cl + As₂O₃ + Sb₂O₃ |

The glass ceramics are characterized by the main crystalline phases: HQMK, keatite.

Particularly preferable, both glass ceramic types mentioned above can also be used as outside bulbs for metal halide high pressure discharge lamps.

The following examples should describe the present invention without limiting the scope thereof. As will be apparent from the above description for a person skilled in the art, the present invention comprises a series of further aspects which basically could also be claimed separately and independently.

### EXAMPLE 1

Example 1 describes compositions of alkali-containing glass ceramics which have proved to be favourable in tube take-up tests and which are suitable for uses according to the present invention in the form of a tube: LAS (Li₂O—Al₂O₃—SiO₂) glass ceramic in the form of a tube (alkali-containing)

| Main ingredient: | Proportion [MA %] |
|---|---|
| 67.2 | SiO₂ |
| 21.4 | Al₂O₃ |
| 3.8 | Li₂O |
| 1.1 | MgO |
| 1.7 | ZnO |
| 2.2 | TiO₂ |
| 1.7 | ZrO₂ |
| 0.2 | As₂O₃ |
| 0.1 | K₂O |
| 0.4 | Na₂O |
| 0.016 | Fe₂O₃ |
| Sum | 99.8 |

### EXAMPLE 2

Example 2 describes the composition of an alkali-free glass ceramic which is suitable for uses according to the present invention in the form of a tube:

Alkali-free glass ceramic of the system MAS (MgO—Al₂O₃—SiO₂) in the form of a glass ceramic tube

| Main ingredients: | Proportion [MA %] |
|---|---|
| 58.5 | SiO₂ |
| 20.3 | Al₂O₃ |
| 4.2 | MgO |
| 8.4 | ZnO |
| 3.0 | TiO₂ |
| 5.0 | ZrO₂ |
| 0.5 | As₂O₃ |
| Sum | 99.9 |

The material of example 2 was used for the viscosity measurements (referred to as AF-GC in graphic 1 in example 3 below).

### EXAMPLE 3

### Preferred Properties Regarding Thermal Stability

The thermal stability can be modified by synthesis and different ceramication programs. For the evaluation of the stability, the viscosity of the material in dependence of the temperature is used.

In graphic 1, the viscosity (in dependence of the temperature) of the alkali-containing and alkali-free glass ceramics AH-GC and AF-GC useable according to the present invention is compared with the viscosity of aluminium silicate glass and silica glass. It is shown that the glass ceramics are superior in relation to the aluminium silicate glass. With performing the tests, the long term stability of the ceramics could be confirmed each.

### EXAMPLE 4

### Preferred Properties Regarding UV Absorption

Graphic 2 below shows that glass ceramics to be used according to the present invention have a better blockage of UV radiation compared to starting glass for glass ceramics.

Here means:
AH GC Green: alkali-containing starting glass
AH GC Ceram. 1: alkali-containing glass ceramic, ceramicated according to temperature regime 1
AH GC Ceram. 2: alkali-containing glass ceramic, ceramicated according to temperature regime 2.

The measurements were conducted at tubes having a wall thickness of 0.3.

It is appreciated that from the same starting glass, glass ceramics with different optical properties (in this case regarding to the position of the UV edge) can be prepared by an adjustment of the ceramication conditions.

### EXAMPLE 5

Graphic 3 shows the transmission curves (transmittance [%] vs. wave length [nm]) of a further embodiment example (glass ceramic A1) and a comparison example V1 for the range of wave lengths of 300 nm to 550 nm. The measurements were conducted at samples with a thickness of 0.3 mm.

The glass ceramic of embodiment example A1 according to the present invention is an LAS (Li₂O—Al₂O₃—SiO₂) glass ceramic of the following composition:

| Main ingredient | % by weight |
|---|---|
| SiO₂ | 67.1 |
| Al₂O₃ | 21.3 |
| Li₂O | 3.8 |
| MgO | 1.1 |
| ZnO | 1.7 |
| TiO₂ | 2.6 |
| ZrO₂ | 1.7 |
| As₂O₃ | 0.2 |
| K₂O | 0.1 |
| Na₂O | 0.4 |

The ceramication is conducted in a multistep method characterized by heating periods and residence times. In this case, the maximum temperature does not exceed 1000° C. and the residence times are adjusted to the optimum crystallite growth. The crystallite size is normally in the order of 20 to 90 nm and the proportion of the crystalline phase is at least 50%.

The comparison example V1 is a glass of the following composition:

| Main ingredient | % by weight |
|---|---|
| SiO₂ | 71.65 |
| TiO₂ | 4.0 |
| B₂O₃ | 16.9 |
| Al₂O₃ | 1.15 |
| Na₂O | 3.75 |
| K₂O | 1.45 |
| CaO | 0.6 |
| MgO | 0.4 |
| As₂O₃ | 0.1 |

Graphic 3 shows a UV blockage of the glass ceramic A1 which is in addition clearly improved in comparison to the already well UV blocking glass V1 despite the low content of TiO₂ in A1, with a very small transmission loss in the visible range which can be ignored.

A1 is preferable in comparison to V1 regarding to some base properties which are relevant for use: So α_{20/300} which is ca. 0×10⁻⁶/° K is clearly below the value of V1 (3.9×10⁻⁶/° K), which has the consequence that the material is more resistant with respect to temperature changes, e.g. in hot lamps. Furthermore, a better adjustment to silica glass is given, a material which is also often used in the field of lamp construction. The maximum thermal stressing of A1 is at least 850° C. (below that, the material does not deform any longer) in comparison to ca. 550° C. for V1 (Tg˜500° C.).

Due to its better UV blockage, A1 is more suitable as a constituent of a lamp than V1, in particular for lamps of apparatuses which comprise plastic constituents which tend to yellowing, e.g. for backlights. In this case, actually in particular the UV A-range (about 365 nm) is blocked: Here, the result is an improvement (reduction) of 30 transmission percentage points % (i.e. absolute) or more, as shown in FIG. 2.

### EXAMPLE 6

Graphic 4 shows the transmission curves (250 to 550 nm) of the embodiment example A1 and a further embodiment example A2 which is different from A1 only due to its reduced content of TiO₂ (2.0% by weight, instead of 2.6) as well as its increased content of Al₂O₃, ZnO and ZrO₂ (0.1% by weight each), as well as of two comparison examples V2 and V3 which correspond to the green glasses of A1 and A2, that is the non-ceramicated basis glasses, wherein V2 has the same composition as A1 and V3 has the same composition as A2.

The measurements were conducted at samples with a thickness of 0.3 mm.

Graphic 4 illustrates not only the improvement of the UV blockage due to the increase of the content of TiO₂ (V2 vs. V3), but in particular the strong improvement of the UV blockage due to the ceramication (A1 vs. V2 respectively A2 vs. V3).

### EXAMPLE 7

Graphic 5 shows the transmission curves of embodiment examples according to the present invention which are referred to as A1a and A1b. Ala and A1b have the same composition as A1 (see above). However, due to variations in the ceramication program, they comprise crystallites with an average crystallite size of ca. 30 nm (A1a) respectively ca. 50 nm (A1b) which were measured by X-ray diffractometry.

The measurements were conducted at samples with a thickness of 4 mm.

Graphic 5 shows that by variation of the particle size a fine tuning of the UV edge is possible. In this case, the particle size was adjusted by a variation of the ceramication conditions, especially the maximum temperatures/residence times of the step of crystal growth. Graphic 5a also shows a transmission curve of A1, however in comparison to the transmission curve of the commercially available glass V4, as well as further the curve (A4) of a glass ceramic of the type ZERODUR®, a further example of LAS glass ceramics having mixed high quartz crystals as crystalline phase with no expansion. This glass ceramic is featured by average crystallite sizes of higher than 68 nm and a proportion of the crystalline phase of higher than 70% by volume.

The measurements were conducted at samples with a thickness of 0.2 mm.

The curves show that the glass ceramics A1 and A4 according to the present invention, also in comparison to the glass V4 which is commercially used for UV blockage applications, also in lamps, have good transmission properties, namely a high transmission in the visible range and a UV edge which is steep enough.

Comparison example V4 is a commercial glass having the following composition (in % by weight):

| | |
|---|---|
| SiO₂ | 68.5 |
| Na₂O | 10.9 |
| K₂O | 4.7 |
| CaO | 5.0 |
| BaO | 4.0 |
| ZnO | 2.8 |
| TiO₂ | 1.5 |
| CeO₂ | 2.6 |

### EXAMPLE 8

In graphic 6a below, transmission curves of the glass ceramics A1 and A2 according to the present invention are compared with the data of a comparison glass V5. Now, the corresponding samples have a thickness of 1 mm.

The comparison glass V5 has the following approximate composition:

| | | |
|---|---|---|
| SiO₂ | 99.2% | by weight |
| CeO₂ | 0.8% | by weight |

By the absorption of Ce⁴⁺, the range up to ca. 320 nm is blocked very well and the UV edge is steep. However below 300 nm, no sufficient screening off is achieved.

If the glass is used e.g. in metal halide high pressure discharge lamps as outside bulb, UV radiation with short wave lengths (from the discharge of mercury) can leave the lamp. In this case, an additional UV protection is necessary.

Both glass ceramics A1 and A2 according to the present invention are preferred in relation to V5, because they do not facilitate any passage of radiation below ca. 330 nm. Their transmission at 400 nm is higher than 80%.

As shown in graphic 6b, the transmission can even reach values of 88% or more by a suitable selection of the composition and the raw materials (see example A3, content of Ti₂O of 2.3% by weight). The comparison example V5 is the same as shown in graphic 6a.

### EXAMPLE 9

### Preferred Properties Regarding the Degeneration Through UV Absorption (Solarisation)

Graphic 7 below shows that, at irradiation with UV light, aluminium silicate glass suffers from degeneration, namely that it has lower transmission values after UV irradiation. Thus, the transparency of conventional glass deteriorates after the exposure of UV radiation. Such an effect does not occur with the glass ceramics to be used according to the present invention, as can be seen from FIG. 5 (the courses of the curves of the irradiated and non-irradiated materials correspond to the non-irradiated material respectively to the material which was irradiated with UV light for 15 hours).

According to transmission data of samples of aluminium silicate glass and an alkali-containing glass ceramic (originally non-irradiated respectively UV irradiated for 15 hours), there is an absolute decrease of the transmission at 750 nm of 0.8% (91.3 to 90.5%) for aluminium silicate glass, whereas for the glass ceramic no shift to lower values can be observed, as can be seen in graphic 7 below.

### EXAMPLE 10

### Production Method for the Glass Ceramic to be Used According to the Present Invention

The starting glasses of the glass ceramics to be used according to the present invention can be prepared by the means of melting at a temperature 1, fining at a temperature 2 (wherein temperature 2 is higher than temperature 1) and subsequently processing in a crucible in a multistep method.

It is also possible to pre-fine and quench after melting which first step of a two-step method is conducted at high temperatures, such as for example at 1650° C., whereupon during a second step, then it is melted a second time, post-fined and processed. Step 1 of the two-step method should be conducted in a silica glass crucible, wherein step 2 can then be performed in a platinum crucible. For example, the second melting can be performed at 1450° C. in a PtRh₁₀ crucible (volume of 4 litres) with a directly positioned nozzle for 2 hours, followed by post-fining at 1450° C. for 12 hours and then at 1500° C. for 4 hours. Then the nozzle is “melted free” by means of a burner, wherein a part of the glass ceramic is discarded. Subsequently, the hot forming will be conducted, for example at 1475° C. to 1485° C. The glass ceramic tube thus formed will be kept warm by means of a muffle kiln at 1080° C. which is provided afterwards. For the formation of tubes, the needle inside the nozzle is important which can extend from the nozzle up to 10 mm. A suitable inner diameter of the nozzle can be 35 mm.

Suitable tube dimensions for the glass ceramics obtained are for example: total diameter of 8 mm at a wall thickness of 1 mm and an inner tube diameter of 6 mm which can be reached with take-up speeds of approximately 34 cm/min; total diameter of 10.5 mm at a wall thickness of 1.2 mm which can be reached with take-up speeds of approximately 16 cm/min; total diameter of 13.5 mm at a wall thickness of 1.2 to 1.4 mm which can be reached with take-up speeds of approximately 10 cm/min.

For the uses according to the present invention, it may also be suitable to prepare glass ceramic tubes having other dimensions, glass ceramic sticks or glass ceramics with other design forms. Facilities such as described in the German Patent Application with the Application Number 103 48 466.3 can be used for the preparation of the glass ceramics described herein.

### EXAMPLE 11

Summary of various properties in comparison:

Here, tubes with the same thickness are compared which have been prepared according to analogous methods from the various materials:

| | | Wave length | Wave length | | | | |
|---|---|---|---|---|---|---|---|
| Samples of | Thickness | at a transmis- | at a transmis- | Transmission | Transmission | Transmission | Edge |
| tube take-up | [mm] | sion of 0.1% | sion of 1% | at 313 nm | at 365 nm | at 750 nm | steepness |
| Conventional | 1.0 | 256 | 275 | 38% | 88% | >91% | − |
| aluminium silicate | | | | | | | |
| glass, used e.g. in | | | | | | | |
| halogen lamps | | | | | | | |
| Glass ceramic 1 | 1.0 | 340 | 343 | 0.0% | 62% | 90.9% | + |
| (ceramicated) | | | | | | | |
| Conventional boro- | 0.2 | 301 | 306 | 9.2% | 90% | >91% | + |
| silicate glass, used | | | | | | | |
| e.g. as “backlight” in | | | | | | | |
| flat screens | | | | | | | |
| Glass ceramic 2 | 0.2 | 325 | 329 | 0.0% | 81% | 90.8% | + |
| (ceramticated) | | | | | | | |

1. A use of a glass ceramic containing from 0 to less than 4% by weight of P₂O₅ and/or from 0 to less than 8% by weight of CaO as a part of a lamp screening off UV light.

2. The use according to claim 1, wherein the lamp is selected from a temperature radiator, a high pressure or low pressure discharge lamp.

3. The use according to claim 1 wherein the glass ceramic is present in the form of a tube.

4. The use according to claim 1 wherein the glass ceramic is used in the form of a minimized tube for background lighting in flat screens.

5. The use according to claim 1 wherein the glass ceramic is a lamp vessel and facilitates a hermetically proof crossing from the glass ceramic to an electrical passage.

6. The use according to claim 1 wherein the glass ceramic withstands a lamp operation temperature of higher than 800° C.

7. The use according to claim 1 wherein the glass ceramic at a layer thickness of 0.3 mm has a UV blockage at wave lengths of smaller than or equal to 265 nm.

8. The use according to claim 1 wherein the glass ceramic at a layer thickness of 0.3 mm has a transmission in the visible wave length range of higher than 75%.

9. The use according to claim 1 wherein the glass ceramic is solarisation stable.

10. The use according to claim 1 wherein the expansion coefficient of the glass ceramic is less than 6×10⁻⁶/° K.

11. The use according to claim 1 wherein the glass ceramic is especially used as outside bulb of a high pressure metal halide lamp with aluminium oxide ceramic or silica glass burner.
